(19) United States
(12) Patent Application Publication
(10) Pub. No.: US 2003/0050212 A1
(43) Pub. Date: Mar. 13, 2003

(54) Constituent of washing aid having anti-bacterial or the like component

(76) Inventor: Chingsung Su, Taipei City (TW)

Correspondence Address: Chingsung Su, P.O. Box 82-144, Taipei, TW

(21) Appl. No.: 09/955,592

(22) Filed: Sep. 13, 2001

(51) Int. Cl. C11D 3/48

(52) U.S. Cl. 510/382

(57) ABSTRACT

A constituent of a washing aid having anti-bacterial or the like component is disclosed. The washing aid contains a carrier stored with a high concentration anti-bacterial or the like material capable of releasing effective anti-bacterial component in water with clothings, characterized in that the released effective anti-bacterial components are adsorbed onto the clothings.

### BACKGROUND OF THE INVENTION

1. Field of the Invention

The present invention relates to a constituent of washing aid having anti-bacterial or the like component, and in particular, a washing aid which releases an anti-bacterial material to clothing under washing in water.

2. Description of the Prior Art

Taiwanese Patent Publication Nos. 377376, 321213, 321212, 313165, 313164, 251316, relate clothing protection, and formulation of washing powder. None of the citation discloses the releasing of an anti-bacterial material of the washing aid in water.

With respect to types of bactericidal material, there are bactericide, fungicide, germicide and sporocide, and with respect to growth or growth inhibition, these materials are known as bacteriostatic, fungi static and sporostatic.

Heretofore, there is not a single universal effective method to eliminate the threat of microbacteria. There are citation disclosed the use of metallic powder to inhibit growth or to kill bacterial.

W. D. Miller, C. V. Nageli have disclosed the bactericidal of silver, copper and mercury. The plate-like metals of silver, copper and mercury do not have bactericidal efficacy. The powder form of gold, platinum, iron and aluminum will not form into bacterial inhibition band in the winter, and zinc, copper, aluminum and platinum will form into bacterial inhibition band. Publication of Bitter discloses that bacterial on the metallic or alloy metal surface will rapidly die off on copper plate, bronze, silver, gold, lead, platinum, aluminum, tin, cast iron, zinc, steel. The reason of the bactericidal effect is not because of the toxicity of the metal, but due to the oxidation of the surface or the tiny amount of acid contained in the solution causing the dissolution of metallic ions in the solution.

### SUMMARY OF THE INVENTION

Accordingly, it is an object of the present invention to provide a constituent of washing aid having anti-bacterial or the like component, wherein the washing aid contains a carrier stored with a high concentration anti-bacterial or the like material capable of releasing effective anti-bacterial component in water with clothings, characterized in that the released effective anti-bacterial components are adsorbed onto clothing under washing in water.

Yet another object of the present invention to provide a constituent of a washing aid having anti-bacterial or the like component, wherein the washing aid will release an effective anti-bacterial material to the fabrics within the water.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1 and 2 show a preferred embodiment of a constituent of washing aid having anti-bacterial or the like component, illustrating the anti-bacterial material on the surface in accordance with the present invention.

FIG. 3 is another preferred embodiment in accordance with the present invention, illustrating the pocket-like carrier containing the to-be-washed article.

FIGS. 4 and 5 illustrate the enlargement of the anti-bacterial material, not drawn to scale.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

The present invention relates to a constituent of a washing aid having anti-bacterial or the like component.

In accordance with the present invention, the mechanism of anti-bacterial material makes use of concentration difference and the washing aid material to regulate. After the effective component leaves the washing aid, the turbulent flow and the mechanical force within the cleaning solution accelerate the distribution of the effective component. At the final stage, almost all the anti-bacterial material is adsorbed onto the fabrics.

Preferably, the washing aid is a material with multiple pores, the effective component that is released can be quantitatively and qualitative analysed. In order to obtain finer particles, preferably the size is in nanometer. The effective anti-bacterial material is metallic powder, its oxides or ions. These materials will lose in water as a result of high temperature. In the experiment, the nanometer silver powder has a melting point below 200-300° C. It is preferably to introduce the powder at a lower temperature or at a shorter time. Another method is by using the ions. For instance, ceramic series, for example silver carbonate of nanometer in size is used so that the silver ions can be appropriately introduced and adsorbed onto the fabric under cleaning.

Basically, in view of the physical structure of the pores and the difficulties and applicable of the materials which complied with the above concerns can be selected from plastic material, ceramic of organic or inorganic material. Typical examples are silica gel, EVA, stone fabric.

Anti-bacterial material, for example silver ions, of high concentration dispersions towards the low concentration area. By means of a physical stirring and agitating, the anti-bacterial is adsorbed onto the fabric under cleaning. In experiment, Ag ions at 1 ppm concentration possess anti-bacterial effect.

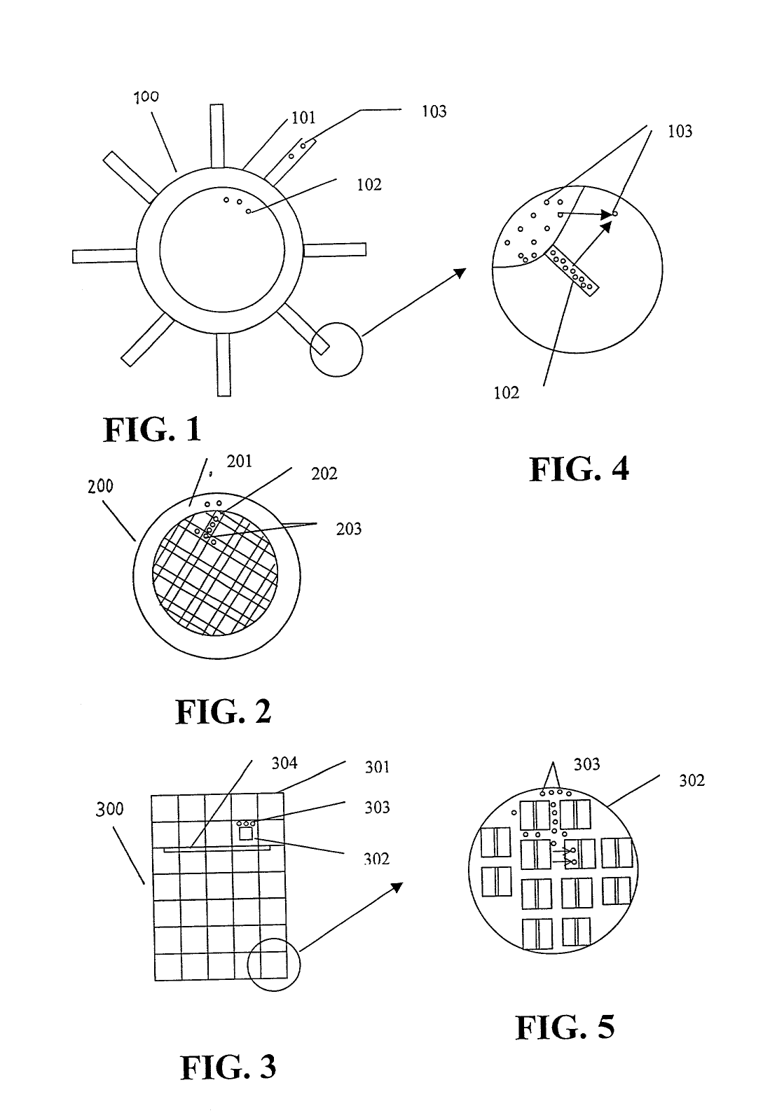

Referring to FIGS. 1 and 2, the washing aid 100, 200 contains a body 101, 201 having rib 102, 202 components, and at least a portion of the rib 102, 202 contains anti-bacterial material 103, 203. Thus, anti-bacterial material of higher concentration when mixed with the cleaning water together with to-be-washed clothings releases the anti-bacterial powder in the cleaning water to adsorb onto the fabric.

The rounded body 101 has the advantage in manufacturing. The ribs 102, 202 are extended from the center of the body.

The round body 101 can be made into a hollow or solid structure to regulate the floating and movement thereof on the water so that the round body can either half float or half sink in the cleaning water. At this moment, the anti-bacterial material will be released into the water as a result of the concentration difference. By means of the external physical force or the change of turbulence of the cleaning water, the anti-bacterial material is dispersed within the cleaning water, and impacts with the fabrics. The anti-bacterial materials adsorbed onto the fabrics within the cleaning water. As the anti-bacterial material is in a minute powdery form, its adsorption onto the fabric will not be dislocated.

Referring to FIGS. 3 to 5, there is shown another preferred embodiment of a washing aid 300, which is in the form of pocket-like body, denoted as 301. The shape of the body facilitates the releasing of the anti-bacterial 302 materials from the rib 302 so as to increase the contact between the cleaning water and the body 301. The body 301 can be a basket shape to allow the to-be-washed clothing to be inserted into the opening 304, reducing the dispersion path of the anti-bacterial material 303.

In actual application, 1 g of MFS 350 anti-bacterial material into 1 kg of raw material can provide a satisfactory result. Of course, the concentration can be adjusted in accordance with the requirements. In experiment, Ag ions oral test LD 50 is larger than 5000 mg1 kg, lethal test LD 50 is larger than 2000 mg1 Kg, which is relatively safe. Preferably the effective anti-bacterial material does not excess 10% of the mass number. The preferable metallic powder is powdery particle of nanometer in size having an excellent surface ratio. That is, under the same physical condition, a reaction surface is larger; preferably the physical size is 200 nanometer, preferably in the range of 50 to 100 nanometers.

Basically, the smaller the size, the effect is more significant. Region A can be directly adsorbed by means of the metallic powder in the solution and the metallic powder has a very fine particles directly mount onto the recess of the uneven space, or between the filament of the fibers so as to obtain better adsorption. In addition, other types of adsorption technology can also be employed, such as CVD, PVD, or Sputtering, CVD, and PVD has to be carried out in vacuum, and the pre-coated material is heated to form gas state, and when it is cooled, it will adsorb onto the surface of the to-be-coated article.

There are different types of sputtering method so as to-be-coated material can form into plasma and is directly ejected onto the substrate.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A constituent of a washing aid having anti-bacterial or the like component, containing a carrier stored with a high concentration anti-bacterial or the like material capable of releasing effective anti-bacterial component in water with clothing under cleaning, characterized in that the released effective anti-bacterial components are adsorbed onto the clothing under cleaning.

2. The constituent of a washing aid of claim 1, wherein the anti-bacterial material is a metallic powder, the oxides or ions thereof.

3. The constituent of a washing aid of claim 2, wherein the anti-bacterial material is a metallic powder non-toxic to human body.

4. The constituent of a washing aid of claim 3, wherein the powdery anti-bacterial material is nanometer in size.

5. The constituent of a washing aid of claim 4, wherein the size of the anti-bacterial material is preferably smaller thin 100 nanometers but larger than one atom.

6. The constituent of a washing aid of claim 1, wherein the carrier of the anti-bacterial material is a hollow or a solid body.

7. The constituent of a washing aid of claim 6, wherein the carrier is a net-like pocket or basket-like body.

8. The constituent of a washing aid of claim 1, wherein the anti-bacterial carrier is a multi-pores organic or inorganic material.

9. The constituent of a washing aid of claim 1, wherein the anti-bacterial is a powder of silver metal.
